(19) United States
(12) Patent Application Publication
(10) Pub. No.: US 2015/0052429 A1
(43) Pub. Date: Feb. 19, 2015

(54) INTERFACE METHOD AND DEVICE

(71) Applicant: CAFFEINEHIT LIMITED, London (GB)

(72) Inventors: Andrew ASHBURNER, London (GB); Tom DRUMMOND, London (GB)

(21) Appl. No.: 14/460,499

(22) Filed: Aug. 15, 2014

Related U.S. Application Data
(60) Provisional application No. 61/866,709, filed on Aug. 16, 2013.

(30) Foreign Application Priority Data
Aug. 16, 2013 (GB) 1314734.3

(51) Int. Cl. G06F 17/21; G06F 3/14

(52) U.S. Cl. CPC G06F 17/212; G06F 3/14
USPC 715/273

(57) ABSTRACT

The present invention relates to a computer-implemented method, comprising: at a device with a touch screen display: displaying a first electronic document, comprising a plurality of locations, each location associated with one of a plurality of further electronic documents; detecting a touch event at or near one of the locations as represented on the touch screen display; translating a first portion of the first electronic document in a first direction; translating a second portion of the first electronic document in a second direction such that the first electronic document is displayed as splitting into the two portions at a split location; and revealing a second electronic document associated with the touched location within an expanding gap between the two portions caused by the translation of the first electronic document. A device and computer readable medium are also described.

### FIELD OF INVENTION

The present invention is in the field of interfaces. Particularly, but not exclusively, the present invention relates to visual interfaces for touch screen devices.

### BACKGROUND

User interfaces are provided to enable users to interact with and view information on computing devices.

On traditional computer systems, a relatively large display is provided in conjunction with a keyboard and mouse or trackpad. The larger display enables users to view and interact with information with a significant degree of context. The user generally interacts with the computing system using a graphical user interface comprising a pointer directed by the mouse or trackpad within a windows paradigm. The windows paradigm comprises user-movable and resizable virtual panels within the display to enable the user to view and interact independently with different electronic documents at the same time.

In the preceding five years, computing devices with smaller displays have become more popular. These computing devices are smart-phones and other portable multifunction devices such as tablet computers. Their displays are often integrated with a touch interface to provide a touch-screen to users.

With the smaller displays, the entire screen is typically utilised to display only one electronic document to a user. When access to a second electronic document is required, the display typically replaces entirely the first electronic document with the second. For example, on the iPhone a second panel comprising the second electronic document scrolls rapidly from the right to the left (when the iPhone is held vertically) to replace a panel displaying a first electronic document. The disadvantage with this technique is that when the user has actuated access to the second document from the first document, the ongoing display of this context to the user is lost. For example, a table view of items within iOS, Android and Windows mobile applications is displayed as a row of summary data. Selection of one of those rows leads to a screen displaying more detailed information. However, the display of this screen replaces the original structure and navigation UI (User Interface) of the table view. To select another row, the user has to navigate back to the original table view. This process is disorientating to the user, does not feel intuitive, and can be time-consuming.

Furthermore, through widespread adoption of touch-screen devices, it has become apparent that innovation within touch-screen interfaces can provide more intuitive control to users than pointer-based interfaces.

One such innovation is pinch-to-zoom where the devices is responsive to a user utilising a two-finger reverse pinch to zoom an electronic document displayed on the touch-screen. Such innovations improve the usability of touch-screen devices.

It would be desirable for the development of a new user interface technology which provides greater context to a user interacting with a touch-screen device.

It is an object of the present invention to provide an improved interface method and device which overcomes the disadvantages of the prior art, or at least provides a useful alternative.

### SUMMARY OF INVENTION

According to a first aspect of the invention there is provided a computer-implemented method, comprising:

at a device with a touch screen display:

displaying a first electronic document, comprising a plurality of locations, each location associated with one of a plurality of further electronic documents;

detecting a touch event at or near one of the locations as represented on the touch screen display;

translating a first portion of the first electronic document in a first direction;

translating a second portion of the first electronic document in a second direction such that the first electronic document is displayed as splitting into the two portions at a split location; and

revealing a second electronic document associated with the touched location within an expanding gap between the two portions caused by the translation of the first electronic document.

The first electronic document may comprise a plurality of items and each location may be associated with an item. Each item may comprise a summary of the further electronic document associated with its associated location. Each item may comprise a text description. Each item may comprise an image. Each item may comprise an address. The plurality of items may be represented within the first electronic document as a list. Following translation of the portions of the first electronic document, the item associated with the touched location may remain displayed. Following the touch event, the item may include additional information displayed within the first electronic document. The split location may be before the item associated with the touched location.

The second document may be a graphic. The second document may be a graphical representation of a map. The touched location may be associated with a geographical location within the map. The graphical representation of the map may be centred on the geographical location.

The second document may be one selected from the set of a video, a text document, a web-page and a gallery of images.

The first direction may be a vertical direction.

The second direction may be opposite to the first direction.

The method of the first aspect may further comprise:

at the device:

detecting a touch event at or near the one location;

translating the first portion of the first electronic document in a direction opposite to the first direction

translating the second portion of the first electronic document in a direction opposite to the second direction such that the first electronic document is displayed as combining into one from the two portions; and

hiding the second electronic document within the closing gap between the two portions caused by the translation of the first electronic document.

The locations may be defined by boundaries within the electronic document.

According to a further aspect of the invention there is provided a computer readable storage medium having stored therein instructions, which when executed by a processor of a device with a touch screen display cause the device to:

display a first electronic document, comprising a plurality of locations, each location associated with one of a plurality of further electronic documents;

detect a touch event at or near one of the locations as represented on the touch screen display;

translate a first portion of the first electronic document in a first direction;

translate a second portion of the first electronic document in a second direction such that the first electronic document is displayed as splitting into the two portions at a split location; and

reveal a second electronic document associated with the touched location within an expanding gap between the two portions caused by the translation of the first electronic document

According to a further aspect of the invention there is provided a device, including:

A touch screen display;

One or more processors; and

A computer readable storage medium according to the above aspect.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows block diagram illustrating a touch-screen device in accordance with an embodiment of the invention;

FIG. 2: shows a flow diagram illustrating a method in accordance with an embodiment of the invention;

FIG. 3: shows screenshots from a touch-screen device illustrating an interface method in accordance with an embodiment of the invention;

FIG. 4: shows a diagram illustrating the two electronic documents displayed by the interface method in FIG. 3, where the second electronic document is a map graphic;

FIG. 5: shows screenshots from a touch-screen device illustrating an interface method in accordance with an embodiment of the invention;

FIG. 6: shows a diagram illustrating the two electronic documents displayed by the interface method in FIG. 5, where the second electronic document is a gallery of images;

FIG. 7: shows screenshots from a touch-screen device illustrating an interface method in accordance with an embodiment of the invention;

FIG. 8: shows a diagram illustrating the two electronic documents displayed by the interface method in FIG. 7, where the second electronic document is a text document;

FIG. 9: shows screenshots from a touch-screen device illustrating an interface method in accordance with an embodiment of the invention;

FIG. 10: shows a diagram illustrating the two electronic documents displayed by the interface method in FIG. 9, where the second electronic document is a video;

FIG. 11: shows screenshots from a touch-screen device illustrating an interface method in accordance with an embodiment of the invention; and

FIG. 12: shows a diagram illustrating the two electronic documents displayed by the interface method in FIG. 11, where the second electronic document is a web-page.

### DETAILED DESCRIPTION OF PREFERRED EMBODIMENTS

The present invention provides an interface method and system for a touch-screen device.

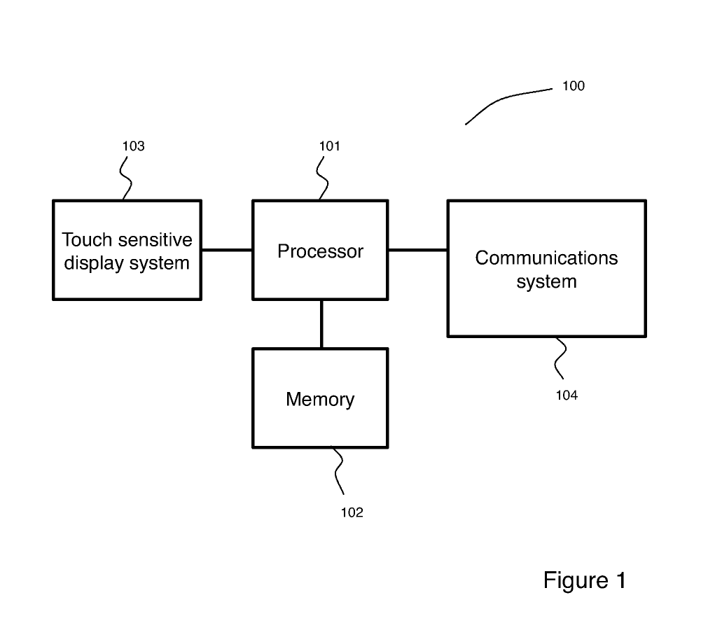

In FIG. 1, a device 100 in accordance with an embodiment of the invention is shown.

The device 100 may be a portable multifunction device such as a smart-phone or tablet computer.

The device 100 includes one or more processors 101.

The device 100 includes a memory 102 connected to the processors 101 by a bus and configured to store an interface module comprising instructions.

The device 100 also includes a touch-sensitive display system 103 connected to the processors 101. The touch-sensitive display system 103 comprises a touch-screen and transmits touch events to the processors 101 and receives data to display from the processors 101.

The device 100 may also include a communications system 104 for communicating with other devices or servers across a communications network such as a cellular communications network or the Internet.

The processors 101 may be configured to execute the interface module. Execution of the interface module may result in the display of a first electronic document on the touch screen of the touch-sensitive display system 103. The interface module may respond to a touch-event at a location within the first electronic document by splitting the first electronic document into two portions and translating (or moving) both portions on the touch screen into two directions (for example apart from one another) to produce an expanding gap between the two portions. The interface module may be configured to reveal within that expanding gap a second electronic document. The second electronic document may be one of a plurality of electronic documents which is associated with the touched location.

The electronic documents may be stored in the memory 102 and/or may be requested via the communications system 104 from another device or server.

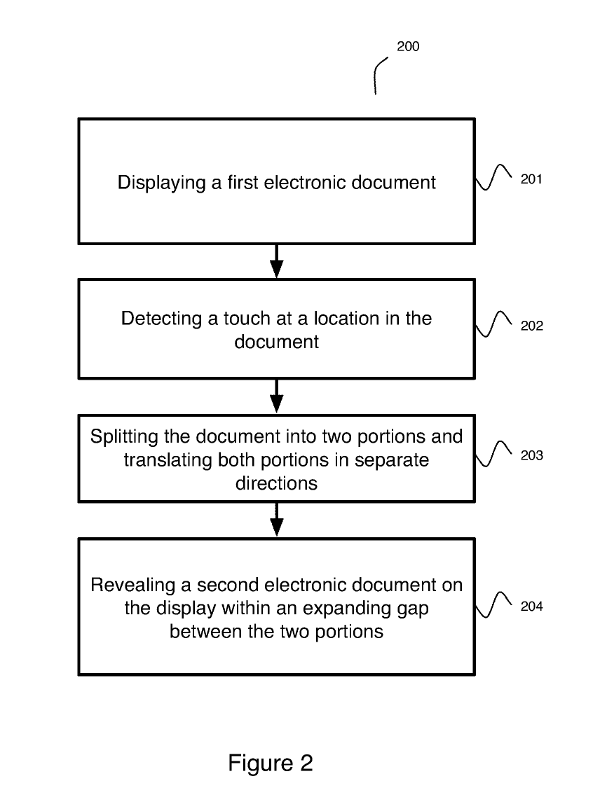

In FIG. 2, a method 200 in accordance with an embodiment of the invention will be described.

In step 201, a first electronic document may be displayed on the touch-screen of the device. The first electronic document may include a plurality of locations which may be defined by a boundary. Each location may be associated with one of a plurality of further electronic documents.

The further electronic documents may be of one particular type. The further electronic documents may be maps, graphics, image galleries, videos, or web-pages.

The first electronic document may also comprise a list or table of items. Each item may be associated with, or located at, one of the locations. Each item may comprise content including one or more of a text description, an image or images, or an address. The content may summarise or relate to an associated further electronic document.

In one embodiment, touch events may be detected on the touch screen to scroll the first electronic document up and down on the touch screen to display parts of the first electronic document at the edges of the display on the touch screen. These touch events may be, for example, dragging touch events.

In step 202, a touch event may be detected near or at one of the locations. For example, the touch event may be the press of a finger tip within the boundary defining the location.

In step 203, and in response to the touch event, the first electronic document may be split into two portions and translated within the touch screen display into two directions. The two directions may be opposite from one another, and may be vertical (when the device is held vertically). Translation of the portions creates an expanding gap between the portions.

In step 204, a second electronic document may be revealed on the touch screen display by the expanding gap. The second electronic document may be associated with the location.

The portions may be translated such that the at least part of one portion remains displayed after the translation. That part may display the item associated with the location. After the touch event, the item may include further detail relating to the second electronic document.

In one embodiment, a second touch event may be detected which will translate the two portions of the first electronic document to combine them into a single portion and, thus, hide the second electronic document. The second touch event may be a single touch on the item which remains displayed after the initial translation or it may be a dragging touch event dragging the item towards the other portion of the first electronic document.

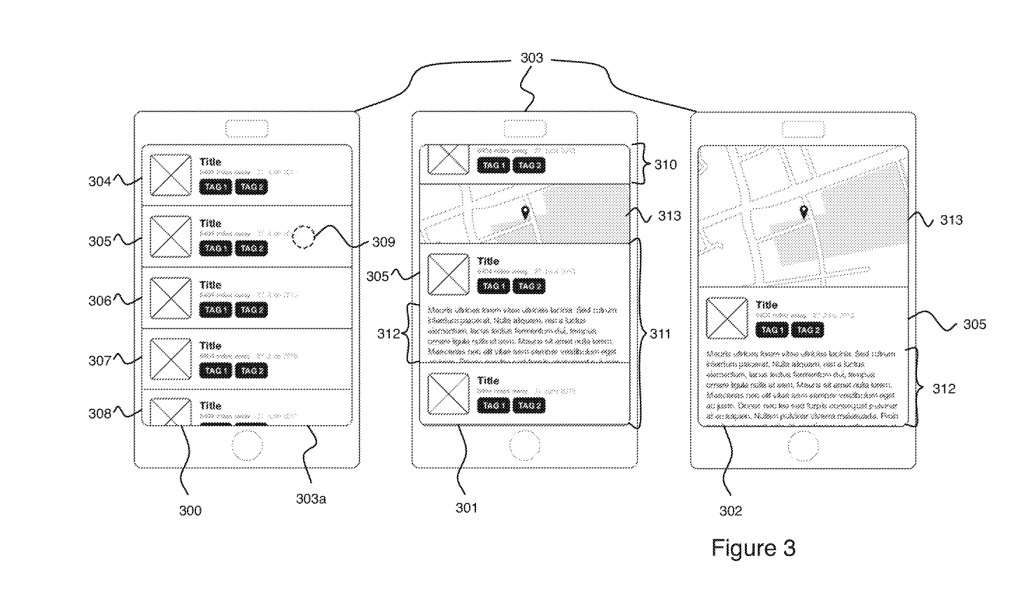

In FIG. 3, an embodiment of the invention will be described with reference to three screenshots 300, 301, and 302 within a portable multifunction device 303.

A first electronic document 303a comprising a table of items 304 to 308 is displayed in 300.

A touch event 309 is detected at item 305.

In response to the touch event, the first electronic document 303a splits into two portions 310 and 311 as displayed in 301. The two portions 310 and 311 translate away from one another. Furthermore, additional information 312 for the item 305 is displayed.

Within the gap between the two portions 310 and 311, a second electronic document 313 is revealed.

In 302, the translation of the portions 310 and 311 has ended. Portion 310 has translated off the top of the display and a part of portion 311 remains displayed. At least a part of item 305 and its additional information 312 remains displayed within that part of the portion 311.

Once the touch event has been received, the first electronic document 303a can be considered as a layer on top of the second electronic document 313 associated with the location of the touch event. That layer then splits into two 310 and 311 to reveal the lower layer 313. The location of the split, in this embodiment, is between the touched item 305 and the item 304 preceding it in the table.

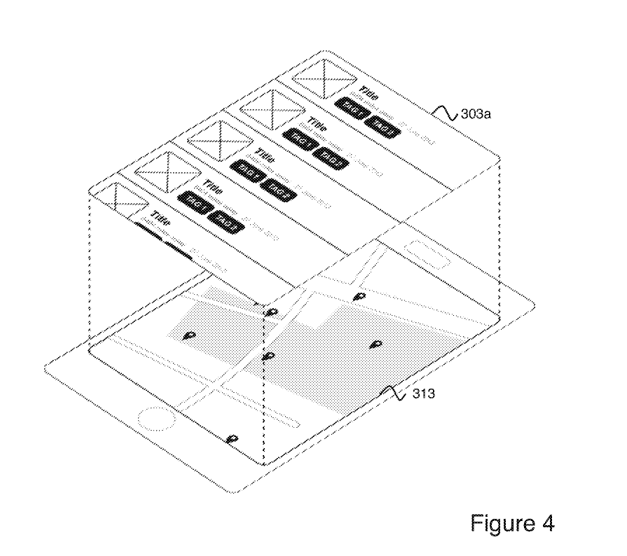

FIG. 4 shows the first and second electronic documents 303a and 313 utilised in the embodiment in FIG. 3. Document 303a is a table comprising rows of summary information for a geographic location. Document 313 is a map graphic centred on the geographic location of the row selected during FIG. 3.

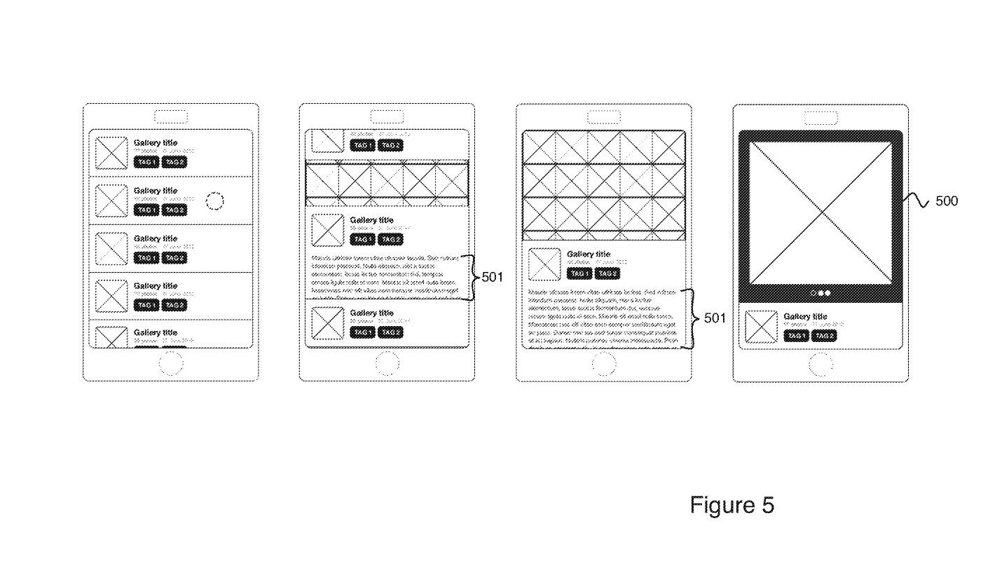

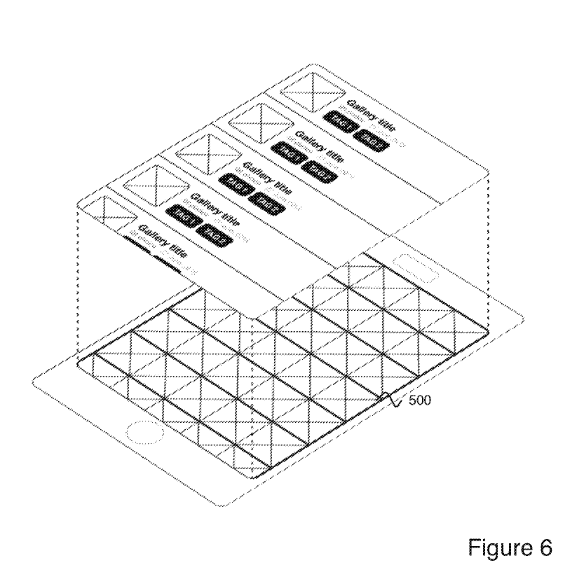

FIGS. 5 and 6 show an embodiment of the invention where the second electronic document 500 is an image gallery. In this embodiment, additional information 501 for the item is also revealed but during translation of the first electronic document this information is hidden.

Further touch events may be detected on the second electronic document 500 and in response different images within the gallery may be displayed. Further touch events such as dragging touch events may be detected on the item and, in response, the additional information 501 may be revealed again.

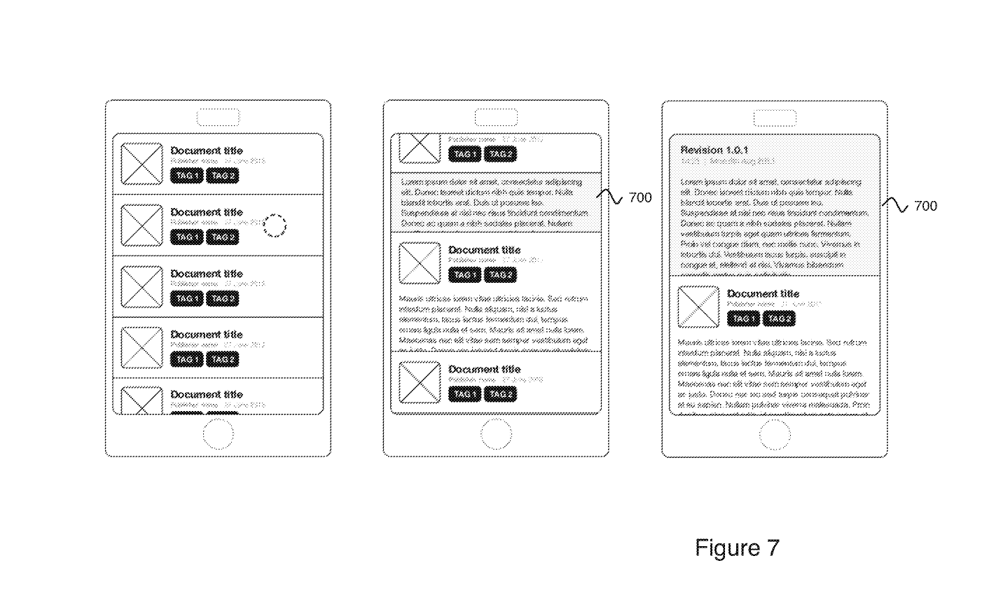

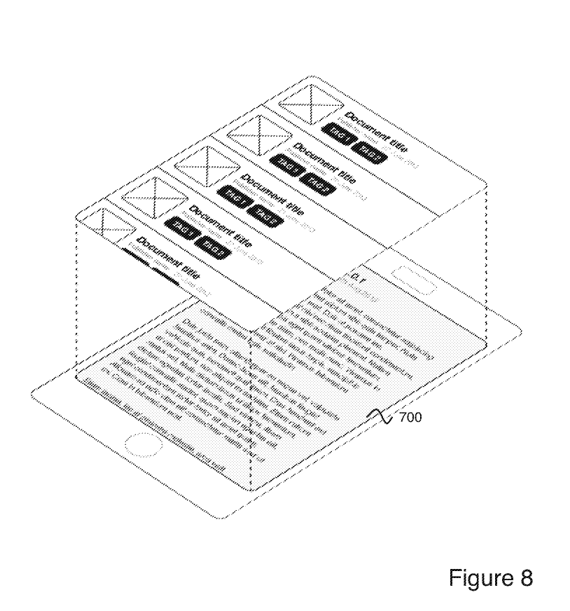

FIGS. 7 and 8 show an embodiment of the invention where the second electronic document 700 is a text document.

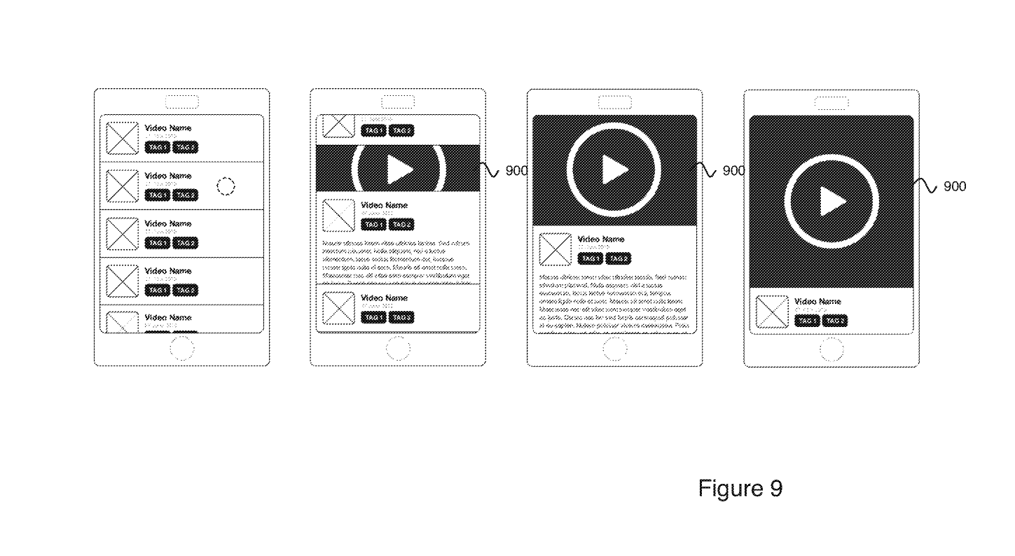

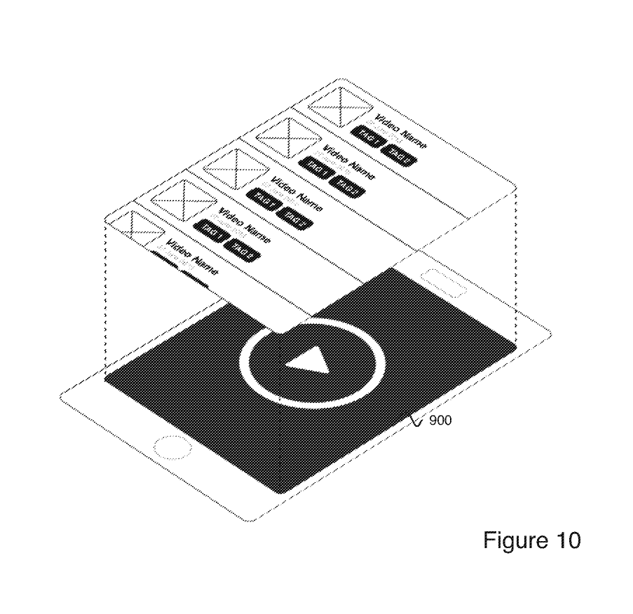

FIGS. 9 and 10 show an embodiment of the invention where the second electronic document 900 is a video.

Further touch events may be detected on the second electronic document 900 and in response the video may be displayed on the touch screen and audio for the video may be played via a speaker of the device or a speaker connected to the device.

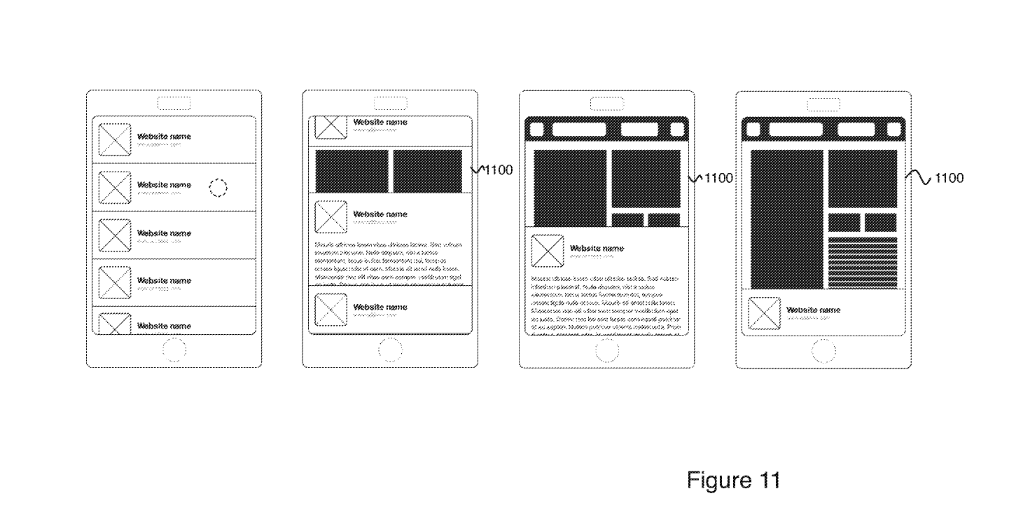

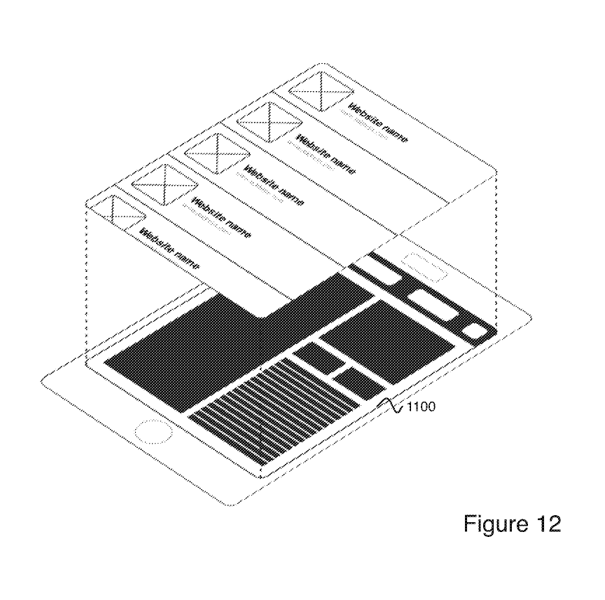

FIGS. 11 and 12 show an embodiment of the invention where the second electronic document 1100 is a web-page.

Further touch events may be detected on the second electronic document 1100 and in response different features of the web-page 1100 may be actuated. For example, touch events on hyperlinks within the web-page 1100 may be detected and in response the document linked by the hyperlink may be displayed in place of document 1100.

The above embodiments may be implemented entirely within hardware or may be implemented, at least in part, in software. The software may be stored within a memory on the device or a portable memory.

A potential advantage of some embodiments of the present invention is that the splitting of the first electronic document enables context from the first electronic document to be provided to the user during the subsequent revealing of the second electronic document. Furthermore, the splitting of the document in response to a touch action may provide an interface which is more responsive and intuitive to users. Layering the first electronic document over the second electronic document may provide the ability to present related content in a visually connected fashion. Display of the touched/selected item may improve typical hierarchical information structures allowing users to quickly and easily navigate between data sources without leaving the first electronic document.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A computer-implemented method, comprising:
at a device with a touch screen display:
displaying a first electronic document, comprising a plurality of locations, each location associated with one of a plurality of further electronic documents;
detecting a touch event at or near one of the locations as represented on the touch screen display;
translating a first portion of the first electronic document in a first direction;
translating a second portion of the first electronic document in a second direction such that the first electronic document is displayed as splitting into the two portions at a split location; and
revealing a second electronic document associated with the touched location within an expanding gap between the two portions caused by the translation of the first electronic document.

2. A method as claimed in claim 1, wherein the first electronic document comprises a plurality of items and wherein each location is associated with an item.

3. A method as claimed in claim 2, wherein each item comprises a summary of the further electronic document associated with its associated location.

4. A method as claimed in claim 2, wherein each item comprises a text description.

5. A method as claimed in claim 2, wherein each item comprises an image.

6. A method as claimed in claim 2, wherein each item comprises an address.

7. A method as claimed in claim 2, wherein the plurality of items are represented within the first electronic document as a list.

8. A method as claimed in claim 7, wherein, following translation of the portions of the first electronic document, the item associated with the touched location remains displayed.

9. A method as claimed in claim 8, wherein, following the touch event, the item includes additional information displayed within the first electronic document.

10. A method as claimed in claim 2, wherein the split location is before the item associated with the touched location.

11. A method as claimed in claim 1, wherein the second document is a graphic.

12. A method as claimed in claim 11, wherein the second document is a graphical representation of a map.

13. A method as claimed in claim 12, wherein the touched location is associated with a geographical location within the map.

14. A method as claimed in claim 13, wherein the graphical representation of the map is centred on the geographical location.

15. A method as claimed in claim 1, wherein the second document is one selected from the set of a video, a text document, a web-page and a gallery of images.

16. A method as claimed in claim 1, wherein the first direction is a vertical direction.

17. A method as claimed in claim 1, wherein the second direction is opposite to the first direction.

18. A method as claimed in claim 1, further comprising:
at the device:
detecting a touch event at or near the one location;
translating the first portion of the first electronic document in a direction opposite to the first direction
translating the second portion of the first electronic document in a direction opposite to the second direction such that the first electronic document is displayed as combining into one from the two portions; and
hiding the second electronic document within the closing gap between the two portions caused by the translation of the first electronic document.

19. A method as claimed in claim 1, wherein the locations are defined by boundaries within the electronic document.

20. A computer readable storage medium having stored therein instructions, which when executed by a processor of a device with a touch screen display cause the device to:
display a first electronic document, comprising a plurality of locations, each location associated with one of a plurality of further electronic documents;
detect a touch event at or near one of the locations as represented on the touch screen display;
translate a first portion of the first electronic document in a first direction;
translate a second portion of the first electronic document in a second direction such that the first electronic document is displayed as splitting into the two portions at a split location; and
reveal a second electronic document associated with the touched location within an expanding gap between the two portions caused by the translation of the first electronic document

21. A device, including:
A touch screen display;
One or more processors; and
A computer readable storage medium according to claim 20.
